(19) United States
(12) Patent Application Publication
(10) Pub. No.: US 2024/0401814 A1
(43) Pub. Date: Dec. 5, 2024

(54) Modular Assembled Electric Fireplace

(71) Applicant: Source Pro Industries Ltd., Kowloon Bay (HK)

(72) Inventors: Jackey Chu, Kowloon Bay (HK); Charles Lam, Kowloon Bay (HK)

(73) Assignee: Source Pro Industries Ltd., Kowloon Bay (HK)

(21) Appl. No.: 18/328,357

(22) Filed: Jun. 2, 2023

(51) Int. Cl. F24C 7/00; F21S 10/04

(52) U.S. Cl. CPC F24C 7/004; F21S 10/046

(57) ABSTRACT

The present disclosure relates to a modular assembled electric fireplace, comprising a display assembly; wherein the display assembly includes a flame screen and a flame generator module, the flame screen is placed in front of the flame generator module, in front of the flame screen is provided with a lighting device, modular ornamental parts are provided above the lighting device.

### TECHNICAL FIELD

The present disclosure generally relates to an electric fireplace and more particularly to a modular assembled electric fireplace.

### BACKGROUND

In most currently available electric fireplaces, an electrical insert portion, which commonly contains a heater, a control panel, a flame generator, simulated logs and a glass frame, typically comes completely assembled and wired. The spindle motor and light source are also wired separately and within the same enclosure as the heater. The electrical insert portion is normally then placed in an opening of a mantel structure, such as a wood mantle. The size and shape of the opening is limited by the size and shape of the electric fireplace insert enclosure. Typically, in this kind of electric fire-places, all the components are assembled and shipped as a single enclosure. These components can not be separately installed by the user since the enclosure can not be opened easily by the user due to the risk of electric shock. Also, it will take up a lot of space for packaging, shipping and storing.

In more recent embodiments, solutions for modular assembled electric fireplace have been presented. These assemblies allow for the traditional fully enclosed construction to be separated into smaller modular parts, thus allowing for more efficient packaging and manufacturing advantages.

US20210404667A1 discloses an electric fireplace including a fireplace housing and a heater assembly, utilizing a flame generator that projects a light effect backwards onto an opaque panel which has bad visual effect. Also, when the flame generator is placed at the front, which is typically built in to the ornamental fireplace grate, it is visible to the user. Therefore, the flame generator is typically built in to the ornamental fireplace grate, which means the grate or logs need to be significantly larger as to house the components that are needed for the generator. Additionally, the flame generator is integrated into the ornamental grate or simulated logs, and the heater and the main circuit boards are integrated into a single module. The disadvantage of such design is that both of the ornamental parts and the flame generator should be illuminated with power source, the ornamental parts either have lights that are wired inside them somehow or have some other type of electrical structure to them. Additionally, the replacement and installation of components is very inconvenient, and the space and cost required for packaging and transportation is also large. Furthermore, the opaque panel cannot be reflective surface, as this would mirror the inner components and make them visible to the end user.

Therefore, in the prior art, there is a need for an electric fireplace, which allows to breakdown into modules for reduced size packaging and then combine them in assembly at the user level and to provide a more realistic flame effect with more realistic ornamental objects, such as a fire grate and logs which can also be mirrored on the flame screen

### SUMMARY

An objective of the present disclosure is to design a modular assembled electric fireplace, which allows to breakdown into modules for reduced size packaging and then combine them in assembly at the end user level. The front lighting device in this disclosure is an independent light module, and different ornaments can be interchanged without being wired. Also, the ornaments no longer needs the flame generator module, it can offer interchangeable ornaments at the front at a lesser cost, since the flame generator module can be shared without affecting the product. This also allows for a reflective flame screen to be used in order to mirror the ornaments adding a visual effect. And, the flame generator module can also be fastened to the flame screen to improve assembly to the end user.

The present disclosure relates to a modular assembled electric fireplace, comprising a display assembly; wherein the display assembly includes a flame screen and a flame generator module, the flame screen is placed in front of the flame generator module, in front of the flame screen is provided with a lighting device, modular ornamental parts are provided above the lighting device.

In certain embodiments, the flame generator module is a packaged module; and the flame generator module includes a flame generator and a rotary electric reflector. The flame generator module is provided with an inclined surface facing the flame screen, and a simulated flame pattern or an opening is provided on the inclined surface.

Further, the rotary electric reflector includes a rotating shaft and some reflecting blades, the reflecting blades are arranged around the rotating shaft at intervals. The flame screen is a transparent or translucent screen, or at least a portion of the flame screen is transparent or translucent to allow light through, or the flame screen is translucent and reflective to allow light through and can add a mirrored effect to ornaments placed in the front. The flame screen may have an opaque structural portion to mount and support the flame generator module. The flame screen can be provided with a folding line, and the flame screen is foldable along the folding line.

In certain embodiments, further comprising an electric insertion assembly, wherein the electric insertion assembly includes a control module and one or more heating modules, one or more heating modules are detachably attached to the control module or installed in separate areas of the electric fireplace and connected with the control module. The flame generator module is electrically connected with the control module, the lighting device is electrically connected with the flame generator module; the control module and the heating module are electrically connected by wires, or by plugs and sockets, or by DC/AC dual connector.

Further, an electronic display screen is provided at the front end of the control module, a main circuit board is enclosed inside the control module, the main circuit board is connected to the electronic display screen.

In certain embodiments, comprising a base panel, wherein the flame screen is attached to the base panel in a foldable manner; comprising side panels, wherein the flame screen are attached with the side panels in a foldable manner; comprising a back panel and side panels, wherein the back panel and the side panels are collapsible and foldable.

Further, the flame generator module and the lighting device is pre-assembled and pre-wired to a foldable base panel.

In certain embodiments, the flame screen has a substrate layer or similar structural frame to provide supporting and mounting to the parts with a cut-out or open area to allow the flame to go through, which allows the display assembly to be un-folded and potentially even be used freestanding. Modular ornamental parts can be cut in half and pre-mounted to the flame screen, the flame screen is translucent and allows the fame effect to be shown through the ornaments. The lighting device is an independent lighting module, and the modular ornamental parts can be interchanged without being wired. The flame generator could include a projector and is remotely placed in an area in the back of the flame screen, and film image could be included to project an image of a flame onto the flame screen.

### BRIEF DESCRIPTION OF THE DRAWINGS

These and other features, aspects, and advantages of the present invention will become better understood with reference to the following description, appended claims, and accompanying drawings, in which similar reference characters refer to similar parts, and in which:

FIG. 1 shows a modular assembled electric fireplace according to the present disclosure, which is installed to an electric fireplace cabinet;

FIG. 2a shows a front view of the electrical insert assembly according to the present disclosure;

FIG. 2b shows a rear view of the connecting location of the control module and the left heating module according to the present disclosure;

FIG. 2c shows a rear view of the connecting location of the control module and the right heating module according to the present disclosure;

FIG. 2d shows a schematic diagram of the assembled electrical insert assembly according to the present disclosure;

FIG. 3 shows the flame screen and the flame generator module according to the present disclosure;

FIG. 4 shows a rear view of the flame screen and the flame generator module connecting to the electrical insert assembly according to the present disclosure;

FIG. 5 shows a front view of the display assembly according to the present disclosure;

FIG. 6 shows an electrical connection of the lighting device to the flame generator module according to the present disclosure, in which a log module or a crystal module is provided above the lighting device;

FIG. 7 shows a schematic diagram of the log module according to the present disclosure;

FIGS. 8a-8d show a second embodiment of the electrical insert assembly according to the present disclosure;

FIG. 9 shows a schematic diagram of connecting the flame generator module to the electrical insert assembly according to the second embodiment of present disclosure;

FIG. 10 shows a cross-sectional view of the electric fireplace according to the present disclosure;

FIGS. 11a-11c show a third embodiment of the electrical insert assembly according to the present disclosure, in which a control module and only a right heating module is shown;

FIGS. 12a-12c show a third embodiment of the electrical insert assembly according to the present disclosure, in which a control module and only a left heating module is shown;

FIG. 13 shows a foldable design of the base panel and flame screen according to the present disclosure;

FIG. 14 shows a schematic diagram of connecting a flame generator module to the unfolded base panel and flame screen as shown in FIG. 13;

FIG. 15 shows another foldable design of the base panel and flame screen according to the present disclosure;

FIG. 16 shows a schematic diagram of connecting a flame generator module to the unfolded base panel and flame screen as shown in FIG. 15;

FIGS. 17-18 show two embodiments of the electric fireplace according to the present disclosure, without any side cabinet;

FIGS. 19-20 show two embodiments of the electric fireplace according to the present disclosure, with only one heating module.

FIGS. 21a-21e show another embodiment of the flame screen according to the present disclosure.

FIGS. 22a-22c show yet another embodiment of the modular assembled electric fireplace according to the present disclosure.

### DETAILED DESCRIPTION

In order to make the objectives, technical solutions and advantages of the present disclosure clearer, the embodiments of the present disclosure will be described below in detail with reference to the accompanying drawings. The technical features in different embodiments of the present disclosure may be combined with each other if not conflicted.

Embodiments of the present invention are described herein in the context of a modular assembled electric fireplace. More particularly, it enables greater flexibility to the consumer for the overall design of the electric fireplace, as well as offering various cost and product development efficiencies. For example, numerous options for different components of the electric fireplace can be incorporated together in any desired manner to provide various alternatives for the consumer in terms of the overall size, shape, design and aesthetic appearance of the electric fireplace.

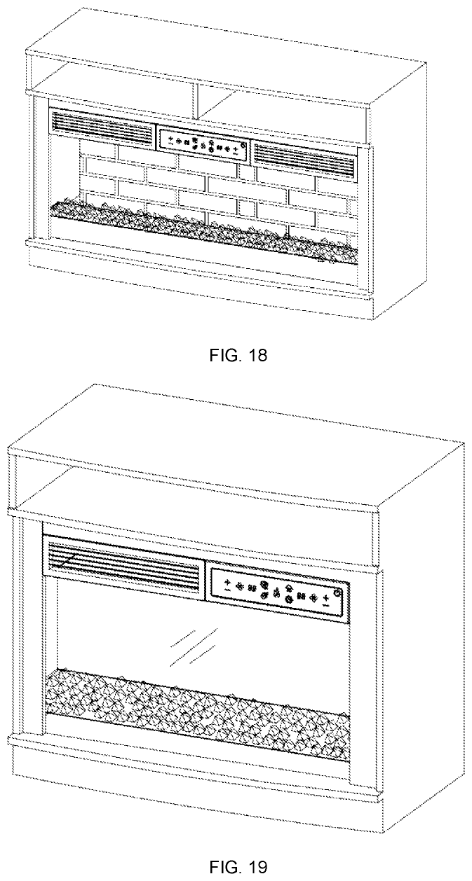

As shown in FIG. 1, a modular assembled electric fireplace 2 according to the present disclosure is installed to an electric fireplace cabinet 1. As shown in the figure, the middle of the electric fireplace cabinet 1 is provided with an opening for installing the electric fireplace 2, and the electric fireplace 2 is installed into the opening of the electric fireplace cabinet. The electric fireplace 2 can have side cabinets on both sides and a top cabinet on top side, and the bottom can be equipped with a base. The design in FIG. 1 is only an example, those skilled in the art know that the electric fireplace 2 may also be installed to other possible positions of the electric fireplace cabinet 1, or may not be provided with at least one of a side cabinet, a top cabinet or a base. Additionally, in certain embodiments, some of the components of the electric fireplace can be positioned in different locations within the electric fireplace. Yet further, in certain embodiments, the cabinet can also be provided to the consumer in the form of a modular cabinet assembly that is configured to be assembled, along with the electric fireplace. FIG. 17-18 shows an embodiment without side cabinets, the electric fireplace of FIG. 17 has a simulation effect of logs, and the electric fireplace of FIG. 18 has a simulation effect of crystal.

Electric fireplace 2 includes an electric insertion assembly 100 and a display assembly 200. The electrical insert assembly 100 is configured to generate and blow out hot wind, and can be adjusted as required, for example, the temperature and speed of the hot wind can be adjusted. Display assembly 200 is configured to display combustion effect, and is electrically connected with the electric insertion assembly 100.

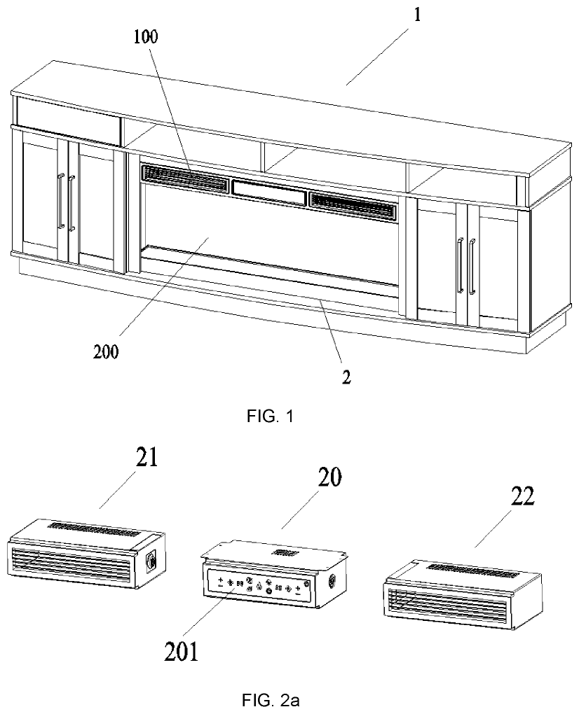

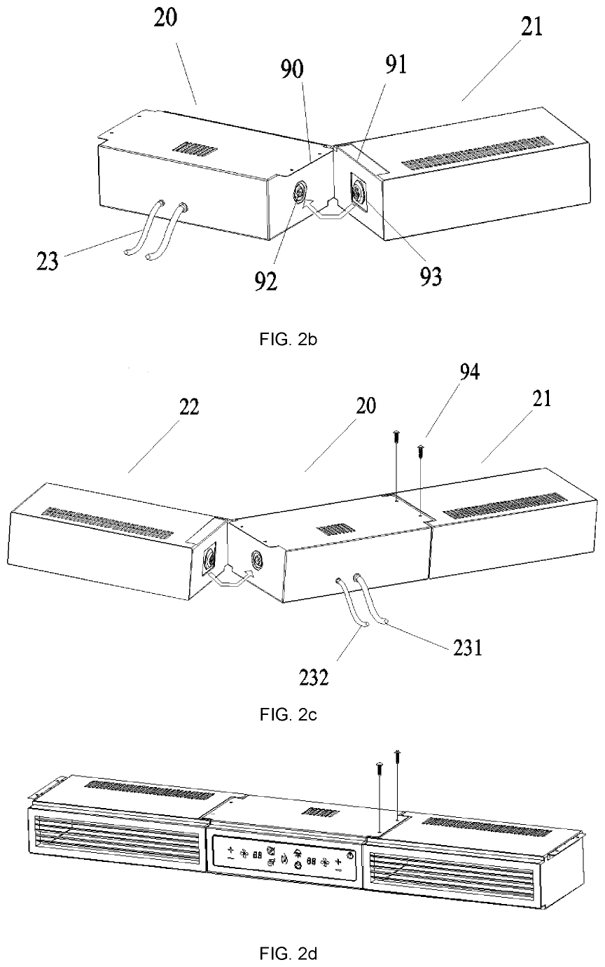

As shown in FIG. 2a, a front view of an electrical insert assembly is shown. The electrical insert assembly 100 includes a control module 20 and at least one heating module. One or multiple heating modules can be directly attached to the control module or installed in separate areas of the fireplace and connected by wires. For example, the control module 20 may be disposed in the middle, the heating module may include a left heating module 21 and a right heating module 22, the left heating module 21 and the right heating module 22 are disposed on the sides of the control module 20, respectively. Those skilled in the art know that the position of the control module and the heating module and the number of heating modules can be adjusted to satisfy the requirement. The front end of the control module 20 is provided with an electronic display screen 201, a main circuit board is enclosed inside the control module 20, the main circuit board is connected to the electronic display screen 201. Control module controls and powers different components by using wires or different types of connectors. The electronic display screen 201 can not only display the working status of the electric fireplace, but also set with control buttons, by which the working state of the electric fireplace could be adjusted and controlled through the main circuit board. Inside the heating module, a heating element is provided, for example, can be a heating rod. An outlet grille can be provided at the front of the heating module, and an outlet grille can also be provided on the top of the heating module. The heating module can be connected directly to the control module or installed in separate areas of the electric fireplace and connected by wire. Compared to the existing systems in which heater and main circuit boards are integrated into a single module, this system has a separate control module which allows the advantage of separately installing the heater and/or hooking up multiple heaters.

The rear view of the control module and the left heating module of the electrical insert assembly are shown in FIG. 2b. The rear end of the control module 20 is provided with a wire 23 to supply power to the electrical insert assembly. The control module 20 and the left heating module 21 are electrically connected by plug 92 and socket 93, plug 92 and socket 93 may be disposed on the sides of the control module 20 and the left heating module 21, respectively. The control module 20 and the left heating module 21 are fixed connected at the top by mounting plate 90 and mounting slot 91, the mounting plate 90 may be disposed on the top of the control module 20, and the mounting slot 91 may be disposed on the top of the left heating module 21. The mounting plate 90 and the mounting groove 91 can be fixed by bolts.

As shown in FIG. 2c, a rear view of the connecting location of the control module and the right heating module is shown. The control module 20 and the right heating module 22 are also electrically connected by a plug and socket, and the plug and socket are disposed on the sides of the control module and the right heating module, respectively. The control module 20 and the right heating module 22 are also fixed connected at the top by a mounting plate and a mounting groove, the mounting plate is disposed on the top of the control module 20, and the mounting slot is disposed on the top of the right heating module 22. The mounting tab and the mounting groove are fixed by bolts 94. Paired wires are connected to the control module 20, including an input wire 231 and an output wire 232, electrical energy is transmitted through the control module 20 to the left heating module 21 and the right heating module 22.

As shown in FIG. 2d, a schematic diagram of the assembled electrical insert assembly is shown. The electrical insert assembly according to the present application is modularly assembled by the control module and two heating modules, and the control module and the heating modules are closely engaged and electrically connected, so that the electrical insert assembly of the present application has the technical advantages of modular manufacturing and installation, which can improve manufacturing and installation efficiency, save packaging and transportation costs.

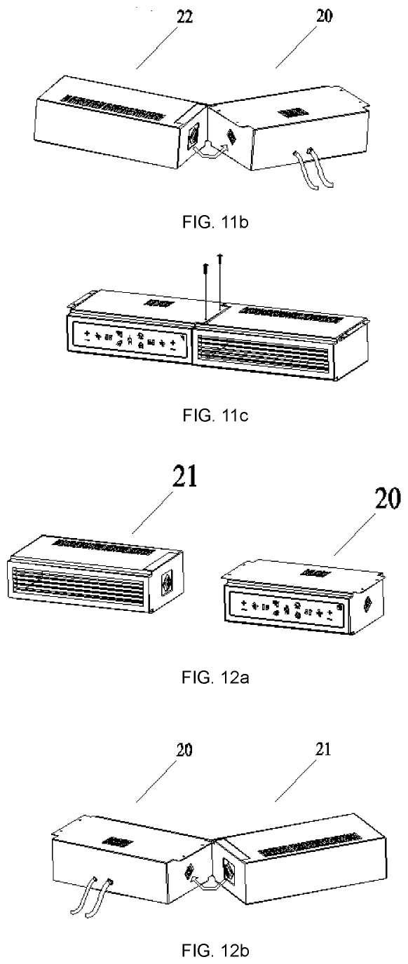

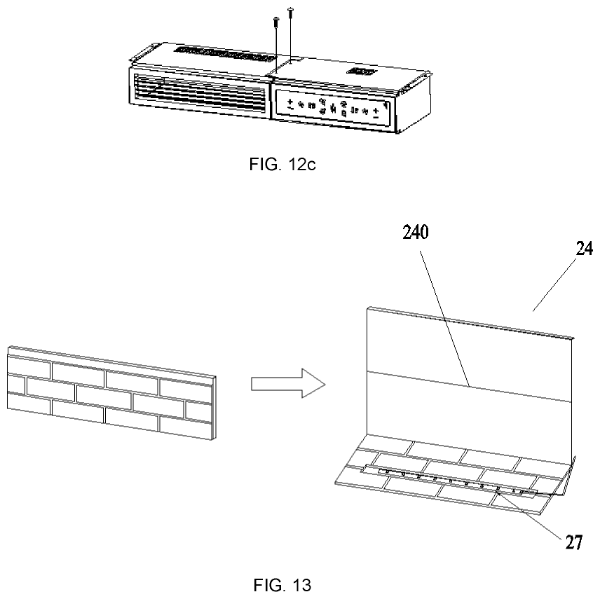

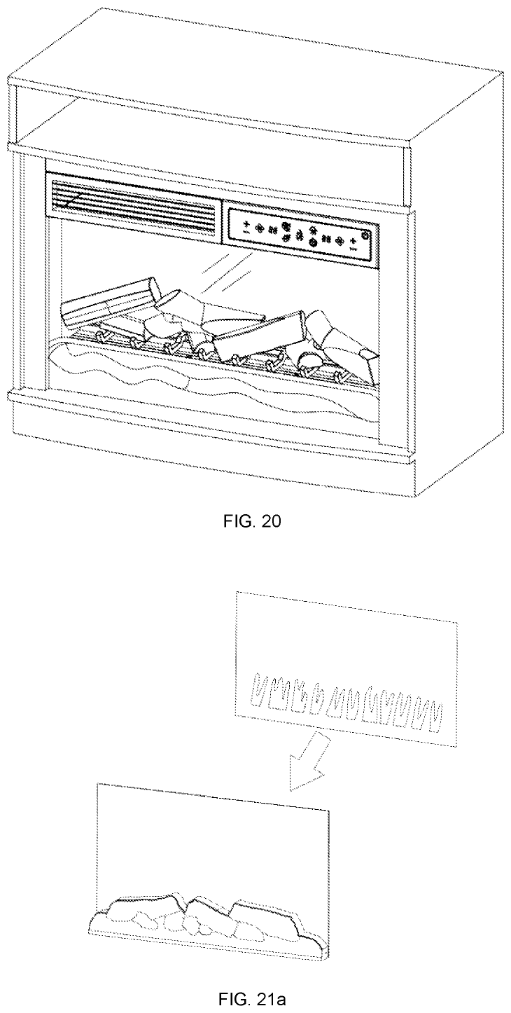

As shown in FIGS. 11a-11c, another exemplary electrical insert assembly is shown, wherein only one a module 20 and one right heating module 22 are shown. As shown in FIGS. 12a-12c, yet another exemplary electrical insert assembly is shown, wherein only a control module 20 and one left heating module 21 are shown. Compared to the embodiment shown in FIGS. 2a-2d, except for the different number of heating modules, the same contact type coupling is adopted. FIGS. 19-20 show the electric fireplaces corresponding to FIGS. 11a-11c and FIGS. 12a-12c, respectively.

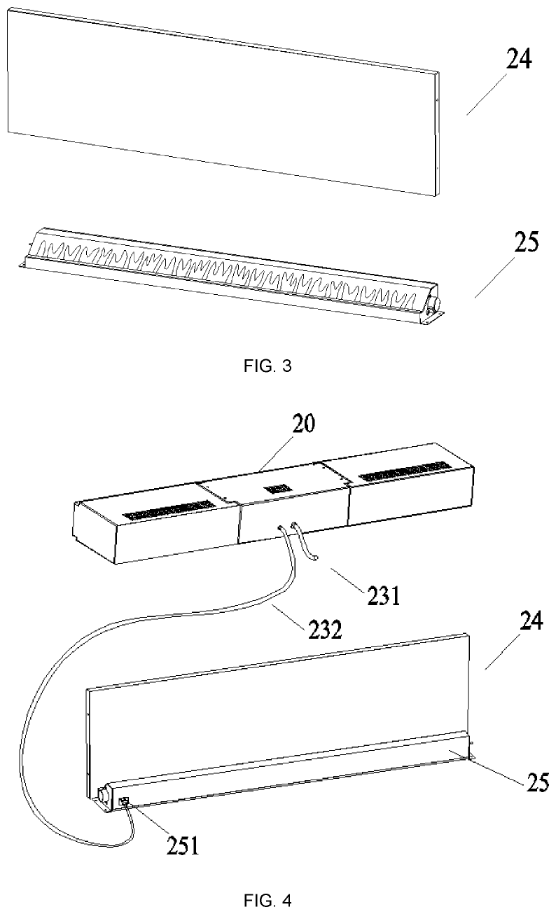

As shown in FIG. 3, the flame screen 24 and the flame generator module 25 are shown schematically. The flame generator module 25 is provided at the rear of the flame screen 24. The flame generator module 25 is also a packaged module. The flame generator module 25 is provided with an inclined surface facing the flame screen 24, and a simulated flame pattern or an opening is provided on the inclined surface. The flame screen 24 can be a transparent or translucent screen and can be made of transparent or translucent materials to allow light through, translucent screen is preferred.

As shown in FIG. 4, the rear view of the flame screen 24 and the flame generator module 25 is shown. The rear end of the flame generator module 25 is provided with an electrical interface 251, an output wire 232 on the control module 20 is connected to the electrical interface 251, in order to provide a low voltage output power to the flame generator module 25.

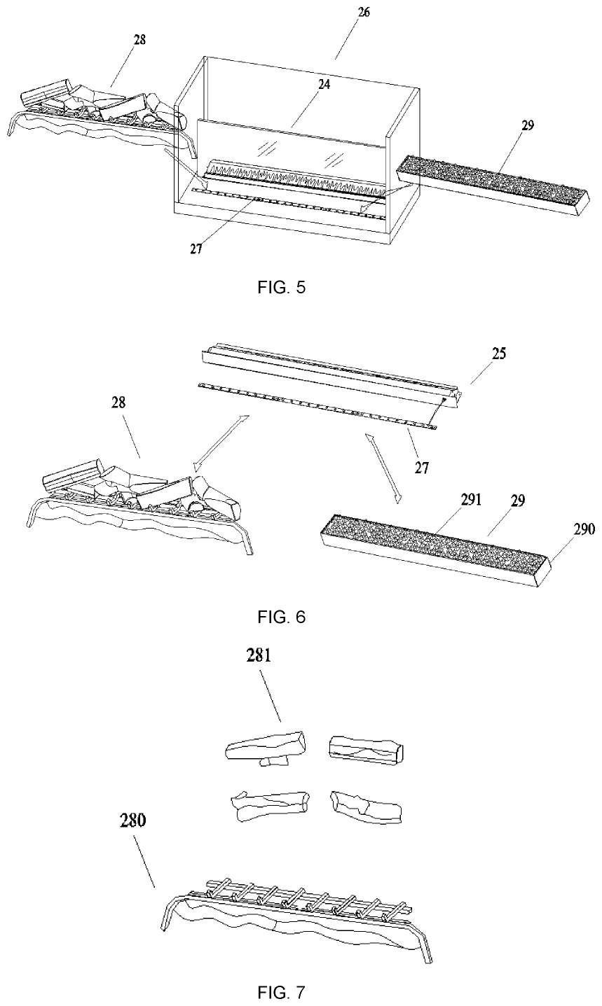

As shown in FIG. 5, a schematic diagram of the display assembly is shown. The display assembly 200 includes a housing 26, which includes a back panel, side panels, a base panel and a front cover (the front cover is not shown), and encloses a cavity. A flame screen 24 and a flame generator module 25 are placed in the cavity, in particular placed on a collapsible base panel. The flame screen 24 is placed in front of the flame generator module 25. The front of the flame screen 24 is provided with a lighting device 27, which may be a light strip or LED lights. The lighting device 27 may illuminate different modular ornamental parts placed above it, such as logs, crystals, and the lighting device 27 is electrically connected to the flame generator. That is to say, the lighting device 27 could be an independent light module and different ornaments can be interchanged without being wired. In this disclosure, ornamental parts can be illuminated without any other power source by being placed over a separately powered light device. For example, at least one of the log module 28 and the crystal module 29 can be provided above the lighting device 27. The lighting device 27 is electrically connected to the flame generator module 25. The lighting device 27 is capable of illuminating the log module 28 or crystal module 29 above. After powering on, the flame generator module 25 displays the flame effect on the flame screen 24, the lighting device 27 illuminates the log module 28 or crystal module 29, and the flame simulation effect can be observed from the front side. Preferably, the flame generator module 25 and lighting device 27 of the present application may be pre-assembled and pre-wired by a foldable base panel, the back panel and the side panels can also be collapsible and foldable. When the side and back panels are folded down, a 4-sided open box can be created. The base, side and back panels, as well as the flame screen are all foldable, so the packaging and transportation size and cost can be reduced.

As shown in FIG. 6, a schematic diagram of the electrical connection of the lighting device to the flame generator module is shown. The flame generator module 25 is provided with a power output port, the lighting device 27 is provided with a power input port, and the two ports are connected by wires. The flame generator module 25 obtains power from the control module 20, and transports to the lighting device 27 and lights the lighting device 27. The log module 28 or crystal module 29 is placed above the lighting device 27 and they are interchangeable. Wherein, the crystal module 29 may include a support base 290, a plurality of crystals 291 are placed on the support base 290. Lighting device 27 may be placed in the bottom space of the support base 290, the support surface of the support base 290 could be made of transparent or translucent material. When the lighting device is lit, the crystal above the support base can be illuminated to create a glitter effect.

As shown in FIG. 7, a schematic diagram of the log module is shown. The log module includes a grate 280 and some log blocks 282, the log blocks 282 are placed above the grate 280, and the lighting device 27 may be placed below the grate 280. When lighting the lighting device 27, it can illuminate the log blocks above the grate, with an effect of log burning.

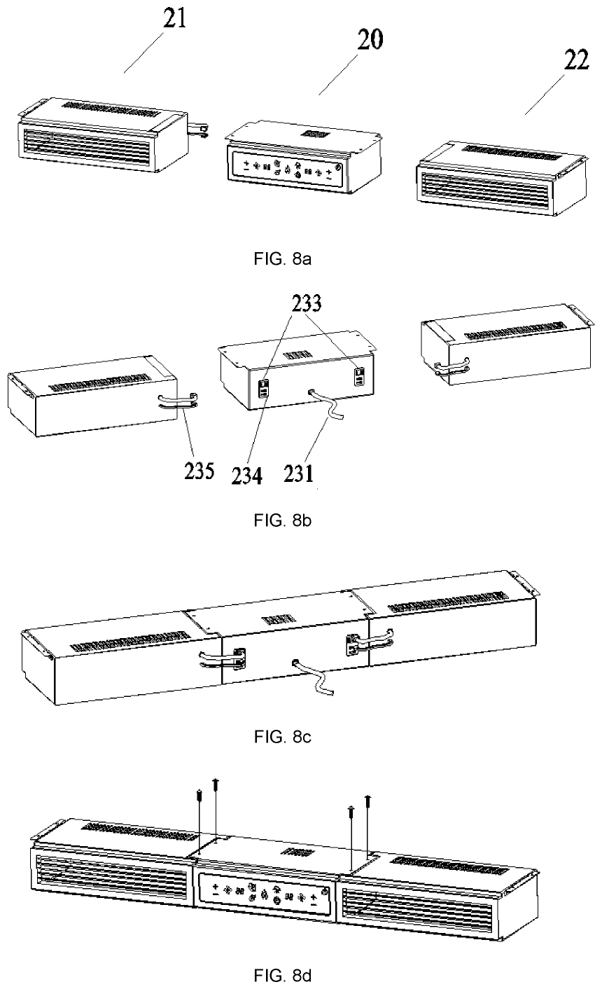

As shown in FIGS. 8a-8d, a schematic diagram of another embodiment of an electrical insert assembly is shown. The electrical insert assembly shown is also formed by modular assembled control module and heating module, which has the technical advantages of modular manufacturing and installation, which can improve manufacturing and installation efficiency and save packaging and transportation costs. The embodiment shown in FIGS. 8a-8d differs from the embodiment shown in FIGS. 2a-2d in that the connection between the control module and the heating module is different. Specifically, in the embodiment shown in FIGS. 8a-8d, the control module and the heating module are electrically connected by wires, rather than plugs and sockets. As shown in FIG. 8b, the rear of the control module is provided with an input wire 231, the control module is also provided with an electrical output port 233, and the heating module is connected to the electrical output port 233 on the control module via wires, thereby realizing an electrical connection of the two modules. The control module is also provided with a contacting connection port 234, and the heating module is connected to the contacting connection port 234 of the control module through the contacting connector 235, thereby realizing the contacting connection of the two modules. Further, the control module and the heating module are also fixed connected on the top by mounting plates and mounting slots, which is the same as the embodiment shown in FIGS. 2a-2d.

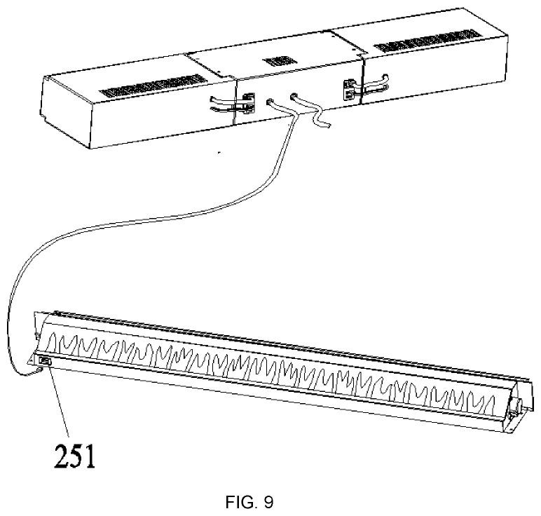

As shown in FIG. 9, a connecting schematic diagram of the flame generator module and the electrical insert assembly is shown. As shown in FIG. 9, the flame generator module is provided with a USB port 251, USB port 251 is electrically connected to the control module of the electrical insert assembly via a wire.

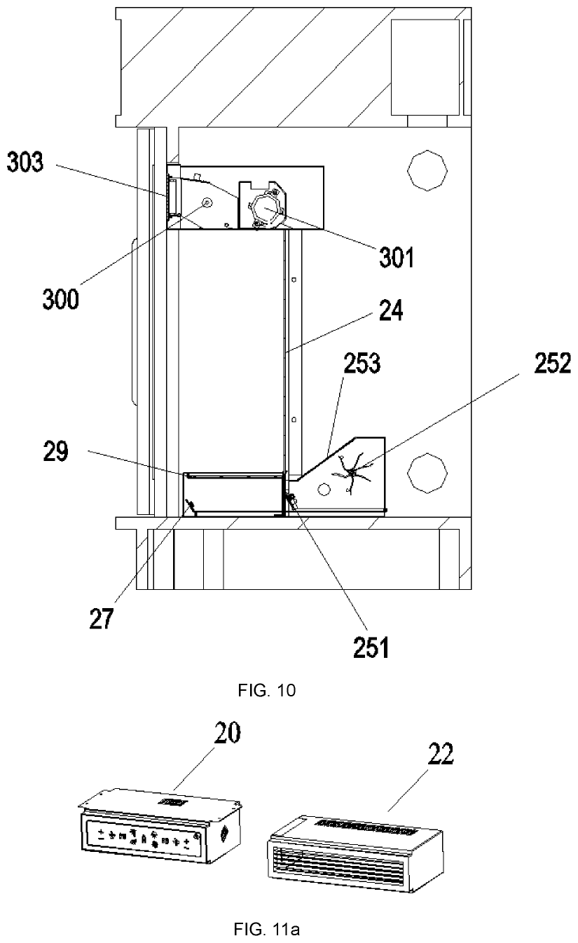

As shown in FIG. 10, a cross-sectional view of an electric fireplace according to the present application is shown, in which a flame generator module has a light assembly with rotary motorized reflector to project a flame onto an attached flame screen. Typically, the heating module includes a heating rod 300 and a blower 301, the heating rod 300 is disposed in a hot wind channel, the blower 301 is positioned nearby the hot wind channel. The wind blown by the blower 301 enters the hot wind channel, and after being heated by the heating rod in the hot wind channel, it is sent out from the outlet grille 303 located at the front side of the heating module. The flame generator module 25 is disposed rear of the flame screen 24, and the flame screen 24 preferably adopts a translucent screen panel. The flame generator module 25 includes a flame generator 251 and a rotary electric reflector 252. The flame generator 251 is capable of emitting different colors of light, and can use different color combinations of bulbs or light strips. Rotary electric reflector 252 includes a rotating shaft and some reflecting blades, the reflecting blades are arranged around the rotating shaft at intervals. The rotating shaft can automatically rotate under the drive of the power supply, thus driving the reflecting blades to rotate. The light emitted by the flame generator 251 is reflected by the rotating reflecting blades, and irradiates onto the inclined surface 253, with the flame pattern on the inclined surface 253, creating a flame burning effect, and displayed on the flame screen 24.

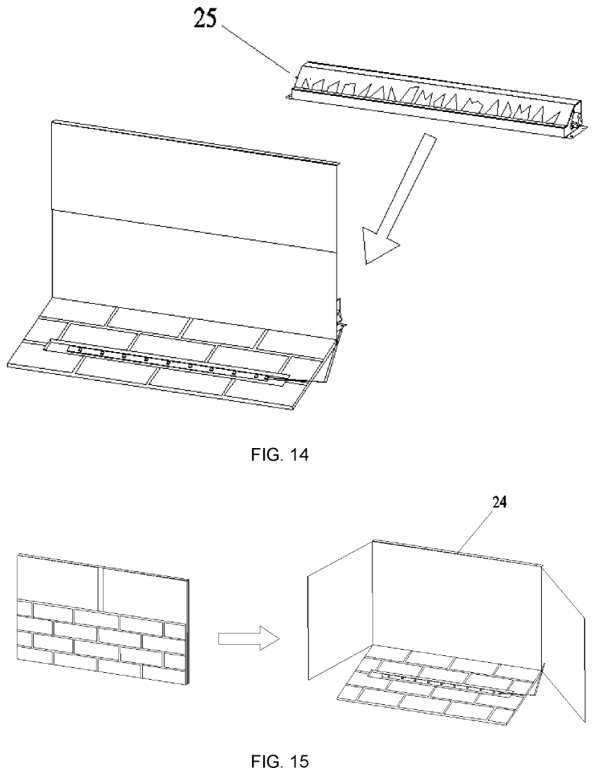

FIG. 13 shows a foldable design of the base panel and flame screen, wherein the left diagram represents the folded state of the base panel and flame screen and the right diagram represents the unfolded state of the base panel and flame screen. The flame screen 24 is provided with a folding line 240, and the flame screen 24 can be folded along the folding line 240. The base panel can be integrated with a lighting device 27, the lighting device 27 may be ember light ECBA. The base panel and the flame screen 24 are connected together in a foldable manner. When folded, the upper and lower parts of the flame screen 24 are folded in half, and then folded together with the base panel. After folded, the packaging size of the base panel and flame screen can be greatly reduced, thereby reducing packaging and transportation costs. As shown in FIG. 14, a schematic diagram of connecting the flame generator module to the unfolded base panel and flame screen is shown. The flame screen 24 can also have an opaque structural portion to mount the flame generator 251 and support the structure upright when free-standing. For example, the flame screen may have a substrate layer to provide structure and mounting to the parts with a cut-out or open area to allow the flame to go through, which allows the display assembly to be un-folded and potentially even be used freestanding.

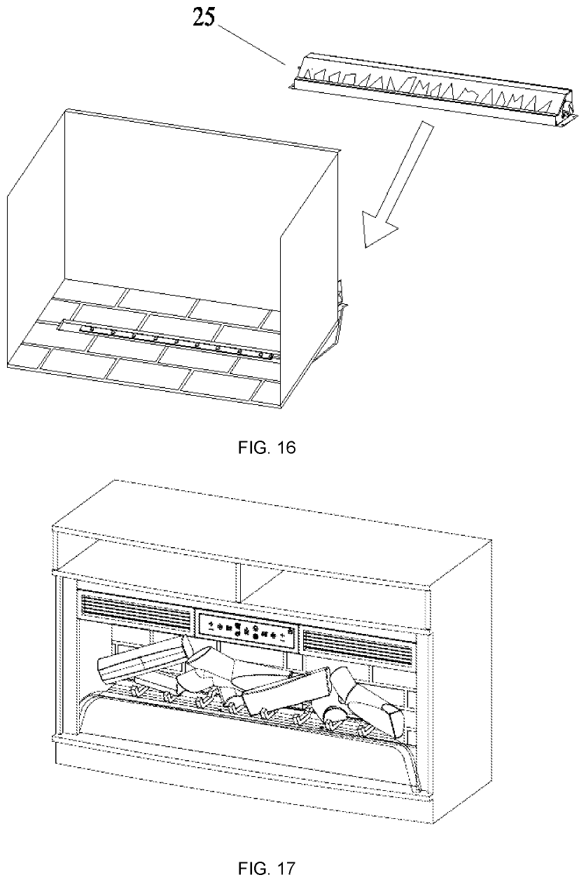

FIGS. 15-16 show another foldable design of the base panel and flame screen. The difference from FIGS. 13-14 is that both sides of the flame screen are connected with side panels in a foldable way. When folded, the two side panels are folded towards the middle and finally against the flame screen, then fold up the base panel to be against the two folded side panels. In this way, the packaging size of the base panel and flame screen can also be significantly reduced, thereby reducing packaging and transportation costs.

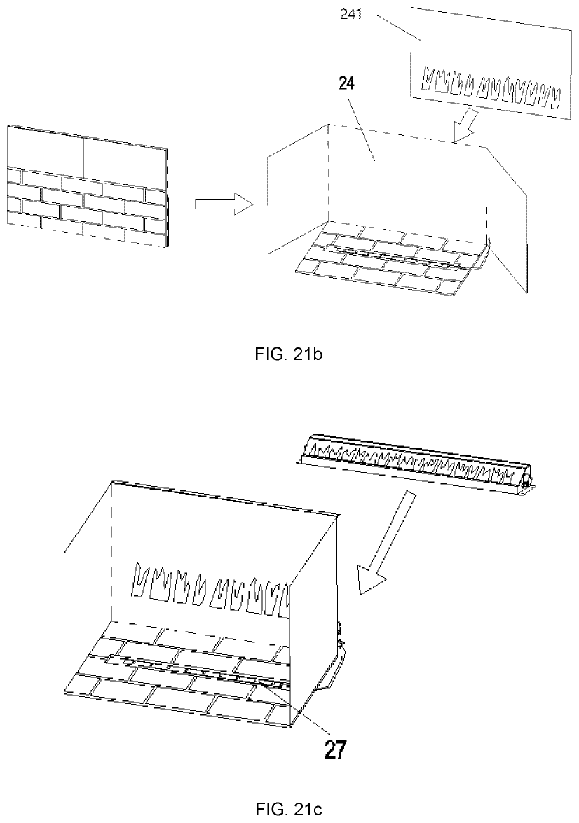

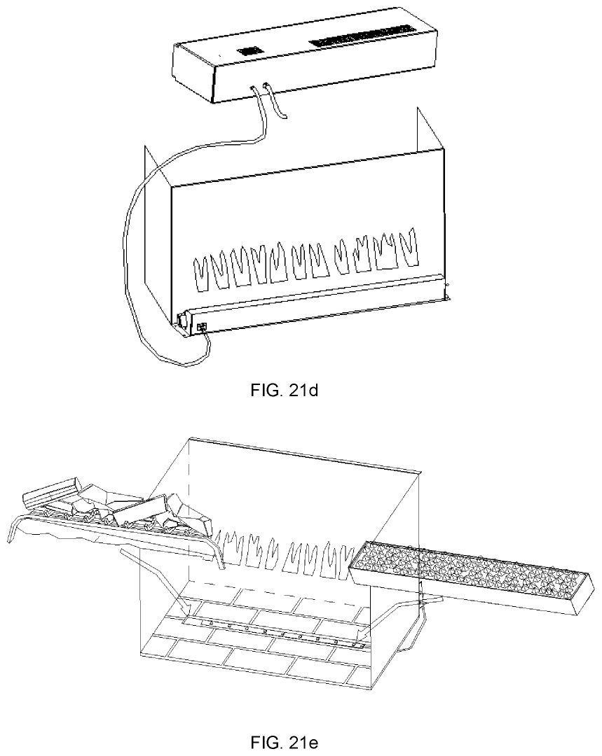

As shown in FIGS. 21a-21e, a log module or a crystal module can be cut in half and pre-mounted to the flame screen, which could include a construction board 241 for the flame screen 24. The flame screen is also translucent and allows the fame effect to be shown through the logs. Such design can also improve assembly as it is a single piece with the log module pre-attached. Basically it is a same flame screen but a variation with the logs pre-attached.

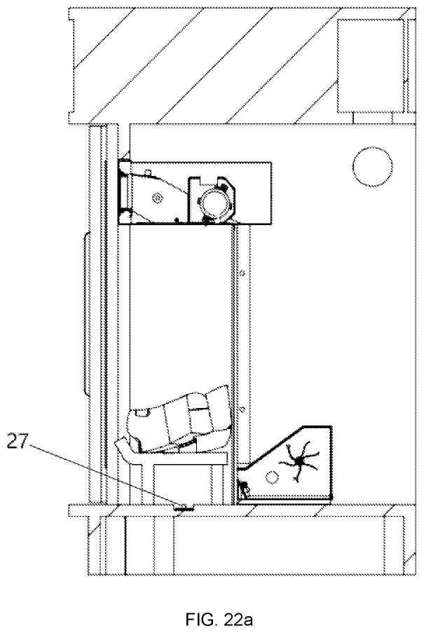

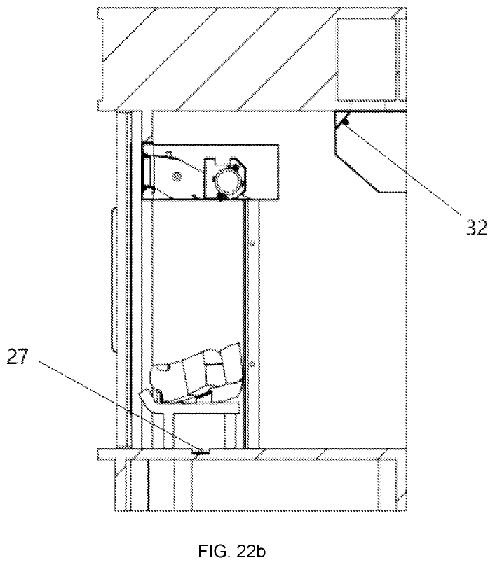

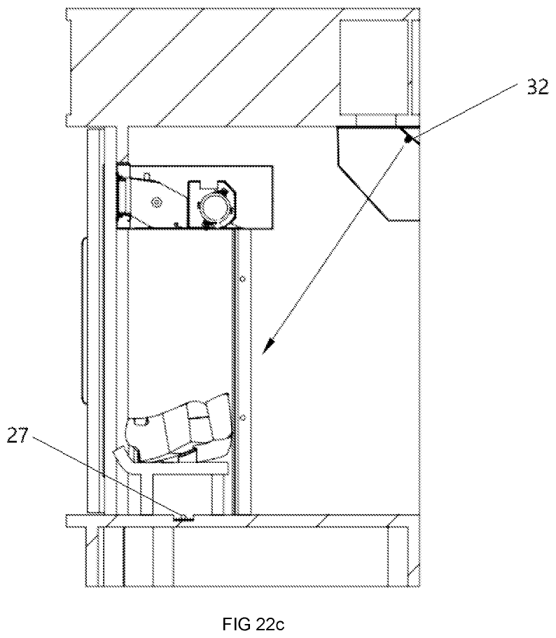

FIGS. 22a-22c show yet another embodiment of the modular assembled electric fireplace according to the present disclosure, which includes a light device 27 at the bottom. Specially, in FIGS. 22b-22c, the flame generator module 25 is provided at the top corner, but not on the base panel. There is a flame generator 32 provided in the flame generator module 25. The light emitted from the flame generator 32 is directly or reflected to illuminate on the flame screen 24. In other embodiments, the flame generator could use a projector type method, which includes a projector. The projector could project from the top back end of a wood cavity opening provided on the flame generator module 25 onto the flame screen 24. Further, a film image could be included to project an image of the flame onto the flame screen. The flame generator can be placed in a remote area in back of the flame screen in order to create more distance and project a larger image, such as near the back panel of the fireplace mantel.

By projecting a light effect forwards onto a transparent or translucent screen, the present disclosure can achieve better visual effect. By placing the flame generator module behind the flame screen and the ornament module, the grate no longer needs the flame generator module. This can offer interchangeable ornaments at the front at a lesser cost and a smaller size, since the flame generator module can be shared without affecting the product. Also, the flame generator is independent of the ornamental log/grate with an independent lighting module at the front of the flame projector in this disclosure. This also allows the advantage of having multiple interchangeable ornaments that do not necessitate built-in lights and reflectors as they can be lit by the independent light module. The flame generator can also be pre-attached to the flame screen which can also be attached to a foldable or collapsible base and side panels for easier installation.

Optional for some embodiments, DC/AC dual connector types for the heating modules which mean DC for motors and AC for heating elements, can be used to replace the connecting type as described above. This will allow to utilize DC motors instead of the more common AC motors. DC motors will give the advantage of better lifespan and other functionality such as RPM variations to create different wind types. Still further, in some embodiments, electrical connections for certain components of the electric fireplace can be configured to enable the consumer to easily and safely establish such electrical connections so that power is provided to all such electrical components of the electric fireplace.

Contact type coupling for heating modules is also optional for some embodiments, which has the advantages of being more convenient and cleaner than using wires. Different types of materials could be suitable for the flame screen, such as vacuumed plastic or compressed paper to create relief for faux stone and textured effects in certain areas, vacuumed or compressed paper to create the shape and log effect directly into the flame screen, and mirrored material to give more depth effect.

It is also possible to combine loose logs and other ornaments such as stones crystals, to allow the consumer to place logs in their preferred configuration, since the grate is not electrified and the illumination comes from a separated light strip module source. Other light strips can be installed in different areas of the mantel to create effects such as downlights, shadows, etc. Further, in various embodiments, the components of the electric fireplace can be configured relative to one another so that they can be packaged together much more compactly, which can provide even further cost efficiencies.

Although the implementations of the present disclosure are described above, the contents descried are only implementations used to understand the present disclosure and not intended to limit the present disclosure. Without departing from the spirit and scope disclosed by the present disclosure, any person skilled in the art to which the application belongs can make any modifications and alterations to the forms and details of implementation. However, the protection scope of the present disclosure shall still be subject to the scope defined by the appended claims.

1. A modular assembled electric fireplace, comprising a display assembly;
wherein the display assembly includes a flame screen and a flame generator module, the flame screen is placed in front of the flame generator module, in front of the flame screen is provided with a lighting device, modular ornamental parts are provided above the lighting device.

2. The modular assembled electric fireplace according to claim 1, wherein the flame generator module is a packaged module.

3. The modular assembled electric fireplace according to claim 2, wherein the flame generator module includes a flame generator.

4. The modular assembled electric fireplace according to claim 2, wherein the flame generator module is provided with an inclined surface facing the flame screen.

5. The modular assembled electric fireplace according to claim 4, wherein a simulated flame pattern or an opening is provided on the inclined surface.

6. The modular assembled electric fireplace according to claim 3, wherein the flame generator module further includes a rotary electric reflector, the rotary electric reflector includes a rotating shaft and some reflecting blades, the reflecting blades are arranged around the rotating shaft at intervals.

7. The modular assembled electric fireplace according to claim 1, wherein the flame screen is a transparent or translucent screen, or at least a portion of the flame screen is transparent or translucent to allow light through, or the flame screen is translucent and reflective to allow light through and can add a mirrored effect to ornaments placed in the front.

8. The modular assembled electric fireplace according to claim 1, wherein the flame screen is provided with a folding line, and the flame screen is foldable along the folding line.

9. The modular assembled electric fireplace according to claim 1, further comprising an electric insertion assembly, wherein the electric insertion assembly includes a control module and one or more heating modules, one or more heating modules are detachably attached to the control module or installed in separate areas of the electric fireplace and connected with the control module.

10. The modular assembled electric fireplace according to claim 9, wherein the flame generator module is electrically connected with the control module, the lighting device is electrically connected with the flame generator module.

11. The modular assembled electric fireplace according to claim 9, wherein the control module and the heating module are electrically connected by wires, or by plugs and sockets, or by DC/AC dual connector.

12. The modular assembled electric fireplace according to claim 8, wherein an electronic display screen is provided at the front end of the control module, a main circuit board is enclosed inside the control module, the main circuit board is connected to the electronic display screen.

13. The modular assembled electric fireplace according to claim 1, comprising a base panel, wherein the flame screen is attached to the base panel in a foldable manner.

14. The modular assembled electric fireplace according to claim 1, comprising side panels, wherein the flame screen are attached with the side panels in a foldable manner.

15. The modular assembled electric fireplace according to claim 1, wherein the flame generator module and the lighting device is pre-assembled and pre-wired to a foldable base panel.

16. The modular assembled electric fireplace according to claim 1, comprising a back panel and side panels, wherein the back panel and the side panels are collapsible and foldable.

17. The modular assembled electric fireplace according to claim 1, wherein modular ornamental parts can be cut in half and pre-mounted to the flame screen, the flame screen is translucent and allows a fame effect to be shown through ornaments.

18. The modular assembled electric fireplace according to claim 1, wherein the flame screen has an opaque or translucent structural portion to mount and support the flame generator module.

19. The modular assembled electric fireplace according to claim 18, wherein the flame screen has a structural layer to provide supporting and mounting to the parts with a cut-out or open area to allow the flame to go through, which allows the display assembly to be un-folded and potentially even be used freestanding.

20. The modular assembled electric fireplace according to claim 1, wherein the lighting device is an independent lighting module, and the modular ornamental parts can be interchanged without being wired.

21. The modular assembled electric fireplace according to claim 3, wherein the flame generator includes a projector and is remotely placed in an area in the back of the flame screen.

22. The modular assembled electric fireplace according to claim 21, wherein film image is included to project an image of a flame onto the flame screen.
